(19) United States
(12) Patent Application Publication
(10) Pub. No.: US 2002/0144138 A1
(43) Pub. Date: Oct. 3, 2002

(54) Method for maintaining a security perimeter during the handling of digital content

(76) Inventor: Richard L. Maliszewski, Forest Grove, OR (US)

Correspondence Address: Mark L. Watson, BLAKELY, SOKOLOFF, TAYLOR & ZAFMAN LLP, Seventh Floor, 12400 Wilshire Boulevard, Los Angeles, CA, 90025-1026, US

(21) Appl. No.: 09/821,271

(22) Filed: Mar. 29, 2001

(51) Int. Cl. H04L 9/00

(52) U.S. Cl. 713/200

(57) ABSTRACT

According to one embodiment, a computer system is disclosed. The computer system includes a compressor/decompressor (codec), and an integrity agent. The integrity agent verifies the authenticity of one or more functions utilized by the codec to assist in the decompression of received content.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever.

### FIELD OF THE INVENTION

The present invention relates to computer systems; more particularly, the present invention relates to digital content protection.

### BACKGROUND

The personal computer (PC) platform is an open and accessible computer architecture. However, the open characteristic of the PC indicates that the PC is a fundamentally insecure computing platform. Both the hardware and software can be accessed for observation and modification. This openness allows malicious users and programs to observe and to modify executing code. For example, software viruses that attack a user's PC have exploited the insecurity of the PC. Software viruses infect PCs by masquerading as popular software or by attaching themselves to other programs. Either a malevolent user or a malicious program can perform such observation or modification.

However, there are classes of operations that must be performed securely on the fundamentally insecure PC platform. These are applications where the basic integrity of the operation must be assumed, or at least verified, to be reliable. Examples of such operations include financial transactions and other electronic commerce, unattended access authorization, and digital content management. The recent use of the Internet as a new content delivery mechanism adds yet another dimension to the uses of PCs. Typically, digital signatures are created and verified using cryptographic techniques. While creating a digital signature, the digital content is compressed and encrypted at a source computer device.

Once received at receiving device, the content is normally decrypted and rendered into a decompressed form. However, after the content is decrypted, and while being decoded, there is a window of vulnerability. During this window of vulnerability, the digital content may be passed on to other components within the computer system for assistance in decompression. These components may not be secure, thus enabling the digital content to be intercepted and copied. Consequently, what is needed is a method for maintaining a security perimeter around components that are used to assist in the rendering of digital content.

### BRIEF DESCRIPTION OF THE DRAWINGS

The present invention will be understood more fully from the detailed description given below and from the accompanying drawings of various embodiments of the invention. The drawings, however, should not be taken to limit the invention to the specific embodiments, but are for explanation and understanding only.

FIG. 1 illustrates one embodiment of a network;

FIG. 2 is a block diagram of one embodiment of a computer system;

FIG. 3 is a block diagram of one embodiment of a trusted player architecture;

FIG. 4 is a flow diagram for one embodiment of the generation of vouchers; and

FIG. 5 is a flow diagram for one embodiment of verification functions executed by an integrity agent.

### DETAILED DESCRIPTION

A method for maintaining a security perimeter around components that are used to assist in the rendering of digital content is described. Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

In the following description, numerous details are set forth. It will be apparent, however, to one skilled in the art, that the present invention may be practiced without these specific details. In other instances, well-known structures and devices are shown in block diagram form, rather than in detail, in order to avoid obscuring the present invention.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined., compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

The instructions of the programming language(s) may be executed by one or more processing devices (e.g., processors, controllers, control processing units (CPUs), execution cores, etc.).

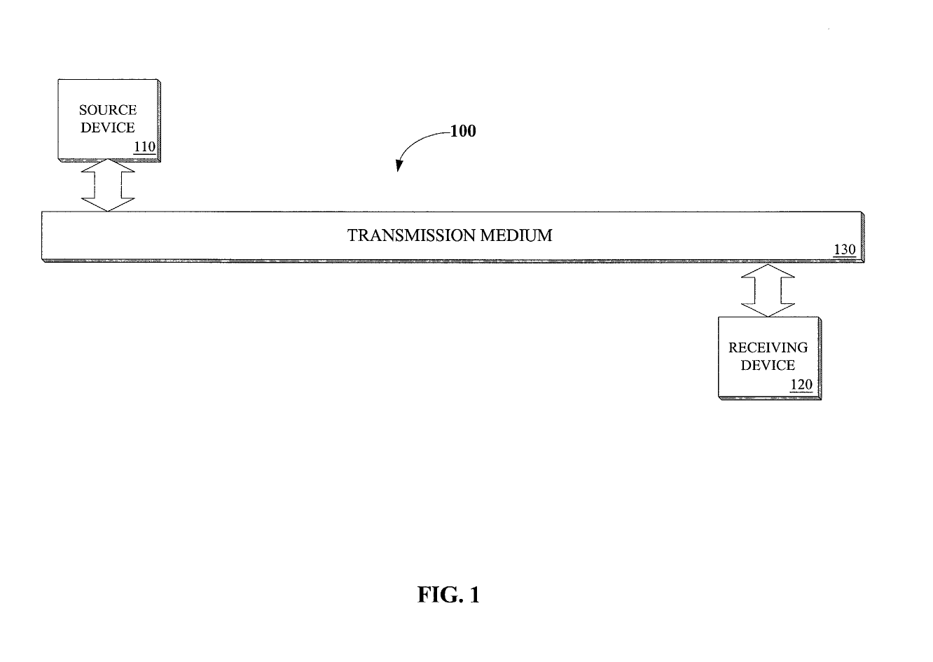

FIG. 1 illustrates one embodiment of a network 100. Network 100 includes a computer system 110 and a computer system 120 coupled via a transmission medium 130. In one embodiment, computer system 110 operates as a source device that sends an object to computer system 120, operating as a receiving device. The object may be, for example. a data file, an executable, or other digital objects. The object is sent via data transmission medium 130. The data transmission medium 130 may be one of many mediums such as an internal network connection, an Internet connection, or other connections. The transmission medium 130 may be connected to a plurality of untrusted routers (not shown) and switches (not shown) that may include the integrity of the object that is transmitted.

According to one embodiment, computer system 110 transmits a signed manifest along with the object to the computer system 120. The signed manifest is a document that attests to the object's integrity. In one embodiment, the signed manifest includes a digest value generated from applying a digest algorithm on an integrity value from the object, and instructions on how to recompute the digest values. The signed manifest may be used by computer system 120 to verify the integrity of the object.

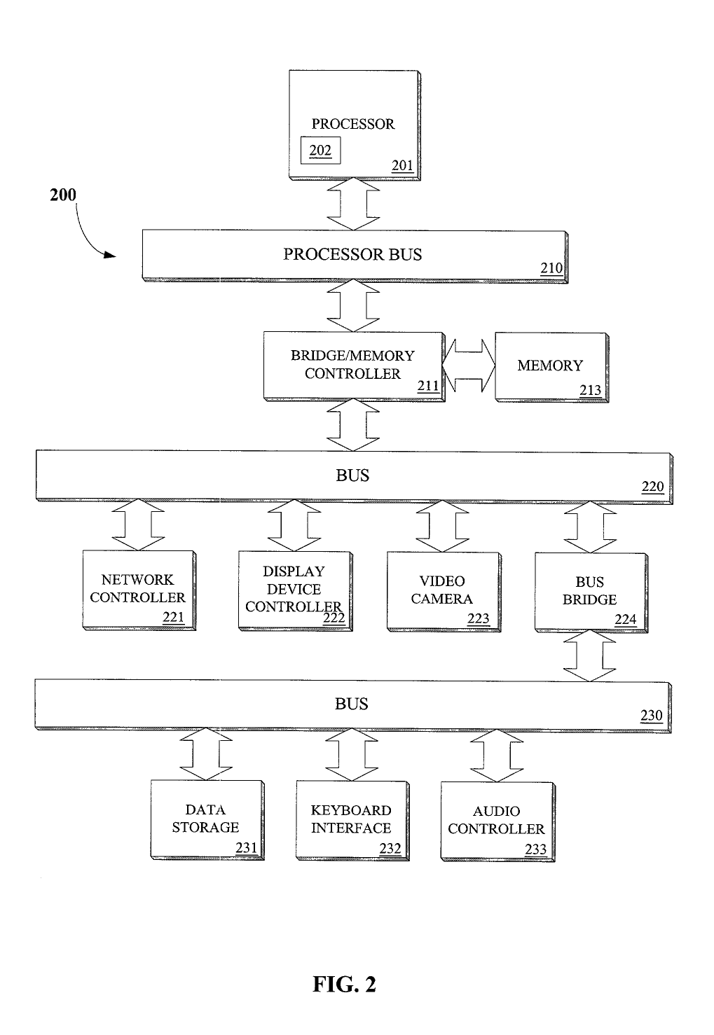

FIG. 2 is a block diagram of one embodiment of a computer system 200. Computer system 200 may be implemented as computer system 110 or computer system 120 (both shown in FIG. 1). The computer system 200 includes a processor 201 that processes data signals. Processor 201 may be a complex instruction set computer (CISC) microprocessor, a reduced instruction set computing (RISC) microprocessor, a very long instruction word (VISW) microprocessor, a processor implementing a combination of instruction sets, or other processor device.

In one embodiment, processor 201 is a processor in the Pentium® family of processors including the Pentium® II family and mobile Pentium® and Pentium® II processors available from Intel Corporation of Santa Clara, Calif. Alternatively, other processors may be used. FIG. 2 shows an example of a computer system 200 employing a single processor computer. However, one of ordinary skill in the art will appreciate that computer system 200 may be implemented using having multiple processors.

Processor 201 is coupled to a processor bus 210. Processor bus 210 transmits data signals between processor 201 and other components in computer system 200. Computer system 200 also includes a memory 213. In one embodiment, memory 213 is a dynamic random access memory (DRAM) device. However, in other embodiments, memory 213 may be a static random access memory (SRAM) device, or other memory device. Memory 213 may store instructions and code represented by data signals that may be executed by processor 201. According to one embodiment, a cache memory 202 resides within processor 201 and stores data signals that are also stored in memory 213. Cache 202 speeds up memory accesses by processor 201 by taking advantage of its locality of access. In another embodiment, cache 202 resides external to processor 201.

Computer system 200 further comprises a bridge memory controller 211 coupled to processor bus 210 and memory 213. Bridge/memory controller 211 directs data signals between processor 201, memory 213, and other components in computer system 200 and bridges the data signals between processor bus 210, memory 213, and a first input/output (I/O) bus 220. In one embodiment, I/O bus 220 may be a single bus or a combination of multiple buses. In a further embodiment, I/O bus 220 may be a Peripheral Component Interconnect adhering to a Specification Revision 2.1 bus developed by the PCI Special Interest Group of Portland, Oreg. In another embodiment, I/O bus 220 may be a Personal Computer Memory Card International Association (PCMCIA) bus developed by the PCMCIA of San Jose, Calif. Alternatively, other busses may be used to implement I/O bus. I/O bus 220 provides communication links between components in computer system 200.

A network controller 221 is coupled I/O bus 220. Network controller 221 links computer system 200 to a network of computers (not shown in FIG. 2) and supports communication among the machines. A display device controller 222 is also coupled to I/O bus 220. Display device controller 222 allows coupling of a display device to computer system 200, and acts as an interface between the display device and computer system 200. In one embodiment, display device controller 222 is a monochrome display adapter (MDA) card. In other embodiments, display device controller 222 may be a color graphics adapter (CGA) card, an enhanced graphics adapter (EGA) card, an extended graphics array (XGA) card or other display device controller.

The display device may be a television set, a computer monitor, a flat panel display or other display device. The display device receives data signals from processor 201 through display device controller 222 and displays the information and data signals to the user of computer system 200. A video camera 223 is also coupled to I/O bus 220.

Computer system 200 includes a second I/O bus 230 coupled to I/O bus 220 via a bus bridge 224. Bus bridge 224 operates to buffer and bridge data signals between I/O bus 220 and I/O bus 230. I/O bus 230 may be a single bus or a combination of multiple buses. In one embodiment, I/O bus 230 is an Industry Standard Architecture (ISA) Specification Revision 1.0a bus developed by International Business Machines of Armonk, N.Y. However, other bus standards may also be used, for example Extended Industry Standard Architecture (EISA) Specification Revision 3.12 developed by Compaq Computer, et al.

I/O bus 230 provides communication links between components in computer system 200. A data storage device 231 is coupled to I/O bus 230. I/O device 231 may be a hard disk drive, a floppy disk drive, a CD-ROM device, a flash memory device or other mass storage device. A keyboard interface 232 is also coupled to I/O bus 230. Keyboard interface 232 may be a keyboard controller or other keyboard interface. In addition, keyboard interface 232 may be a dedicated device or can reside in another device such as a bus controller or other controller. Keyboard interface 232 allows coupling of a keyboard to computer system 200 and transmits data signals from the keyboard to computer system 200. An audio controller is also coupled to I/O bus 230. Audio controller 233 operates to coordinate the recording and playing of sounds.

According to one embodiment, computer system 200 facilitates the verification of the integrity of objects in response to processor 201 executing sequences of instructions in main memory 213. Such instructions may be read into memory 213 from another computer-readable medium, such as data storage device 231, or from another source via the network controller 221. Execution of the sequences of instructions causes processor 201 to facilitate the verification of the integrity of objects.

According to one embodiment, a source device computer system 200 includes a trusted player application (not shown) that builds signed manifests for objects to be transmitted. Generally, the manifest is a credential about the trusted player including a digital signature of the trusted player. Signed manifests describe the integrity and authenticity of an object or a collection of objects. A receiving device computer system 200 also includes a trusted player application for receiving the transmitted object and using the transmitted signed manifest to verify the integrity and authenticity of the object.

According to one embodiment, the integrity description does not alter the object being described, as it exists outside of the object. Accordingly, an object may exist in encrypted form, and processes may inquire about the integrity and authenticity of an object without or its attributes without decrypting the object. A section of the manifest contains a reference to the object, attributes of the object, and a list of digest algorithm identifiers used to digest the object and the associated digest values. The signer's information describes a list of references to one or more sections of the manifest.

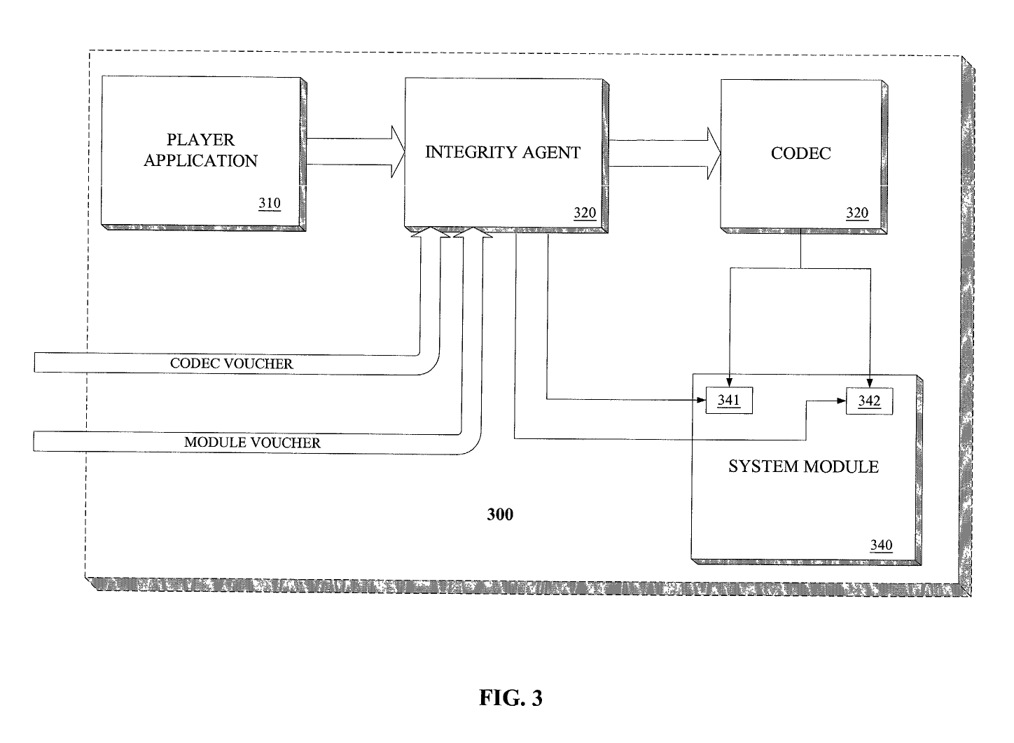

FIG. 3 is a block diagram of one embodiment of a trusted player architecture 300 within a receiving computer system 200. Trusted player 300 is included to read encrypted digital content, decrypt the content, and play the content for the computer system 200 user. Trusted player 300 may be an audio player, or any other type of player (e.g., a video player, a DVD, an electronic document reader, etc.). According to one embodiment, trusted player 300 is implemented by software and resides in memory 213 (FIG. 2) as sequences of instructions. Nevertheless one of ordinary skill in the art will appreciate that the modules may be implemented by hardware as components coupled to I/O bus 220 (FIG. 2) or a combination of both hardware and software.

In a further embodiment, trusted player 300 includes a player application 310, an integrity agent 320, a compressor/decompressor (codec) 330 and a system module 340. Player application 310 receives digital content objects from a source computer system 200 in the form of a signed manifest. Upon receiving an object(s) player application 310 makes a call to integrity agent 320. Integrity agent 320 is used to determine the integrity and authenticity of a received content. Moreover, agent 320 decrypts the content based upon received vouchers. Consequently, integrity agent 320 enforces the conditions of use for the received electronic content.

In one embodiment, integrity agent 320 receives a codec voucher and a module voucher. The vouchers are documents that describe the exact contents of its respective component. For example, the codec voucher describes the integrity of codec 330. Similarly, the module voucher describes the integrity of portions of system module 340 that are going to be called by codec 330. As a result, agent 320 verifies the integrity of codec 330 and the critical portions of system module 340 before passing the content to codec 330.

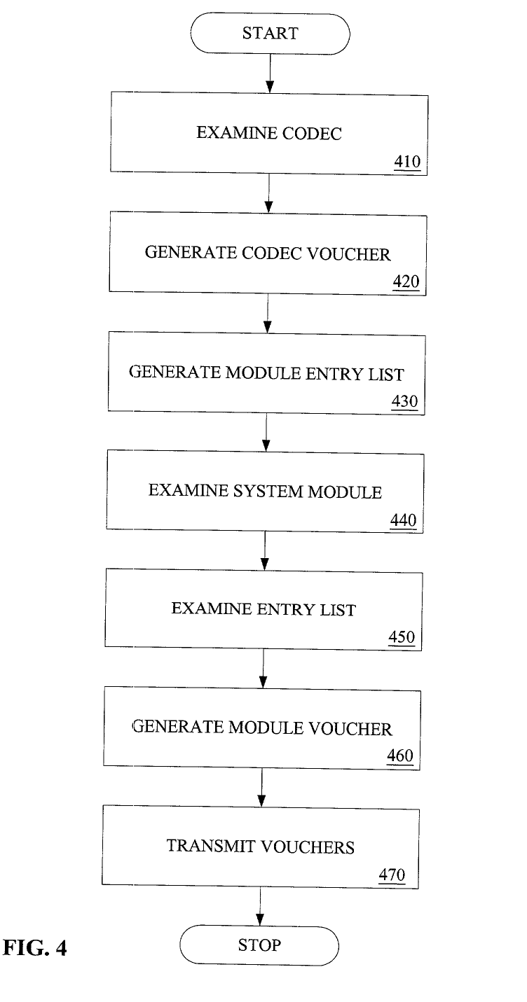

According to one embodiment, the vouchers are generated at the source computer system 200 prior to the playback at the receiving computer system 200. FIG. 4 is a flow diagram for one embodiment of the generation of vouchers. At process block 410, the codec 320 application is examined at the trusted player within the source computer system 200. At process block 420, a codec voucher is generated. In one embodiment, the codec voucher is generated as a signed manifest described above.

At process block 430, a module entry list is generated. The module entry list establishes entries into system module 340 from codec 330 that require protection. The entries correspond to components within system module 340 that assist codec 330 in carrying out its designed function. At process block 440, system module 340 is examined. At process block 450, the module entry list is examined. At process block 460, the module voucher is generated. The model voucher includes the contents of the critical system module 340 components to be used by codec 330. As described above with respect to the codec voucher, the module voucher is generated as a signed manifest.

At process block 470, the codec voucher and module voucher are transmitted to integrity agent 320 within the receiving computer system 200. In one embodiment, the vouchers are transmitted to integrity agent 320 prior to playback. One of ordinary skill in the art will recognize that process blocks 420 and 430 may be processed in a variety of different sequences. For example, the process disclosed in process block 430 may be executed before the process in process block 420. Alternatively, process blocks 420 and 430 may be executed in parallel. Similarly, process blocks 440 and 450 may be processed in a variety of different sequences.

Referring back to FIG. 3, codec 330 is coupled to integrity agent 320. Codec 330 renders the electronic content into a decompressed form. System module 340 is coupled to codec 330. As described above, system module 340 includes functions called by codec 330 to assist codec 330 in rendering compressed content. According to one embodiment, system module 340 may provide such services as memory allocation for codec 330.

In typical player applications the codec is a point of vulnerability. For example, after the content is decrypted by integrity agent 320, and is being decompressed by codec 330, the function calls to components within system module 340 may not be secure. During the function calls, the electronic content may be passed on to the system module 340 components. Since those components are not likely to be secured, the content may be intercepted and copied. One solution to solving this problem is to rework codec 330 so that it no longer makes external function calls during rendering. However, this solution requires either cooperation from the codec 330 vendor who may perform the rewrite, or source-level access and sufficient license rights and expertise to enable the vendor of integrity agent 320 to modify codec 330 so that it longer makes calls to system module 340. Therefore, this solution may not be desirable.

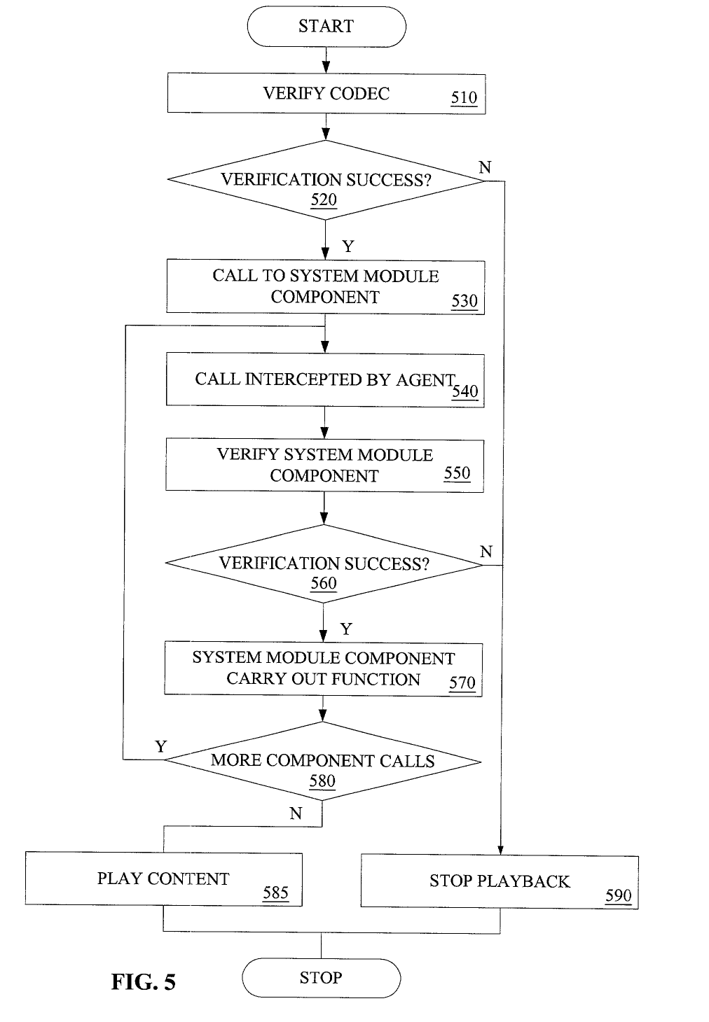

According to one embodiment, integrity agent 320 performs an additional integrity check to extend the security perimeter to include all of the called functions of system module 340. The security perimeter is extended by verifying the previously received vouchers against codec 330 and the relevant portions of system module 340. FIG. 5 is a flow diagram for one embodiment of the verification functions executed by integrity agent 320 during content playback.

Referring to FIG. 5, codec 330 is verified against the codec voucher, process block 510. According to one embodiment, codec 330 is verified by integrity agent 320 computing the digest of an in memory image of codec 330. At process block 520, it is determined whether the verification of codec 330 was successful. The verification is successful if codec 330 matches the codec voucher. If there is not a match between the codec voucher and codec 330, the integrity and authenticity of codec 330 cannot be guaranteed. Therefore, playback is stopped, process block 590.

However, if the verification is successful, codec 330 is permitted to make a call to a component of system module 340, process block 530. At process block 540, the call to system module 340 from codec 330 is intercepted by integrity agent 320. At process block 550, the called component of system module 340 is verified against the module voucher to determine its integrity and authenticity. In one embodiment, the called component of system module 340 is verified by integrity agent 320 computing the digest of an in memory image of the component.

At process block 560, it is determined whether the verification of the system module 340 component was successful. If there is not a match between the module voucher and system module 340, the integrity and authenticity of codec 330 cannot be guaranteed. Accordingly, playback is stopped, process block 590. If the verification is successful, the system module 340 component is permitted to carry out its designated function in assisting codec 330, process block 570. At process block 580, it is determined whether it is necessary for codec 330 to make additional calls to components of system module 340.

If codec 330 requires the assistance of additional system module 340 components, control is returned to process block 540 where codec 330 makes a call to an additional system module 340 component. If codec 330 does not require the assistance of additional system module 340 components, playback of the digital content is presented to the user, process block. 585. The verification of component modules not directly referenced by an integrity agent enables the maintenance of a security perimeter during the handling of high-value, decrypted, compressed digital content.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as the invention.

Thus, a method for maintaining a security perimeter around components that are used to assist in the rendering of digital content has been described.

What is claimed is:

1. A computer system comprising:
a compressor/decompressor (codec); and
an integrity agent, wherein the integrity agent verifies the authenticity of one or more functions utilized by the codec to assist in the decompression of received content.

2. The computer system of claim 1 wherein the integrity agent decodes the received content prior to verifying the one or more functions.

3. The computer system of claim 1 further comprising a system module, wherein the one or more functions utilized by the codec to assist in the decompression of received content codec are included within the system module.

4. The computer system of claim 1 wherein the integrity agent receives a first verification voucher that describes the integrity of the codec.

5. The computer system of claim 1 wherein the integrity agent further receives a second verification voucher that describes the integrity of the functions within the system module that are utilized by the codec to assist in the decompression of the received content.

6. The computer system of claim 1 further comprising a player application.

7. A trusted player comprising:
a compressor/decompressor (codec); and
an integrity agent, wherein the integrity agent verifies the authenticity of one or more functions utilized by the codec to assist in the decompression of received content.

8. The trusted player of claim 7 wherein the integrity agent decodes the received content prior to verifying the one or more functions.

9. The trusted player of claim 7 further comprising a system module, wherein the one or more functions utilized by the codec to assist in the decompression of received content codec are included within the system module.

10. The trusted player of claim 7 wherein the integrity agent receives a first verification voucher that describes the integrity of the codec.

11. The trusted player of claim 7 wherein the integrity agent further receives a second verification voucher that describes the integrity of the functions within the system module that are utilized by the codec to assist in the decompression of the received content.

12. The trusted player of claim 8 further comprising a player application.

13. A method comprising:
receiving content at a compressor/decompressor (codec);
calling a function of a first component of a system module from the codec to assist in decoding the digital content;
intercepting the function call to the first component of the system module at an integrity agent;
and
verifying the authenticity of the first component of the system module at the integrity agent.

14. The method of claim 13 wherein verifying the authenticity of the first component of the system module comprises computing a digest of a memory image of the first component.

15. The method of claim 13 further comprising preventing the playback of the digital content if the first module is not authentic.

16. The method of claim 13 further comprising executing the function call to the first component of the system module if the first module is authentic.

17. The method of claim 16 further comprising:
determining whether the codec is to call a function of a second component of the system module to assist in decoding the content;
if so, intercepting the function call to the second component of the system module at the integrity agent;
and
verifying the authenticity of the second component of the system module at the integrity agent.

18. The method of claim 17 further comprising playing the digital content if it is determined that the codec is not to call a function of a second component of the system module to assist in decoding the content.

19. The method of claim 16 further comprising:
verifying the authenticity of the second component of the system module prior to calling the function of the first component of a system module; and
preventing the playback of the digital content if the codec is not authentic.

20. An article of manufacture including one or more computer readable media that embody a program of instructions for verifying the authenticity of one or more functions utilized by a compressor/decompressor (codec) to assist in decoding the digital content, wherein the program of instructions, when executed by a processing unit, causes the processing unit to:
call a function of a first component of a system module from the codec;
intercept the function call to the first component of the system module; and
verify the authenticity of the first component of the system module.

21. The article of manufacture of claim 20 wherein verifying the authenticity of the first component of the system module comprises computing a digest of a memory image of the first component.

22. The article of manufacture of claim 20 wherein the program of instructions, when executed by a processing unit, further causes the processing unit to prevent the playback of the digital content if the first module is not authentic.

23. The method of claim 20 wherein the program of instructions, when executed by a processing unit, further causes the processing unit to execute the function call to the first component of the system module if the first module is authentic.

24. The method of claim 23 wherein the program of instructions, when executed by a processing unit, further causes the processing unit to:
determine whether the codec is to call a function of a second component of the system module to assist in decoding the content;
if so, intercept the function call to the second component of the system module; and
verify the authenticity of the second component of the system module.
